(19) United States
(12) Patent Application Publication
(10) Pub. No.: US 2008/0289794 A1
(43) Pub. Date: Nov. 27, 2008

(54) Vehicle cooling assembly having a protective screen

(76) Inventors: Frank Joseph Leitch, North Tonawanda, NY (US); Brian J. Coyle, Orchard Park, NY (US); Robert Charles Gmerek, Burt, NY (US)

Correspondence Address: DELPHI TECHNOLOGIES, INC., M/C 480-410-202, PO BOX 5052, TROY, MI, 48007, US

(21) Appl. No.: 11/406,934

(22) Filed: Apr. 19, 2006

Related U.S. Application Data
(60) Provisional application No. 60/716,185, filed on Sep. 12, 2005.

(51) Int. Cl. B60H 1/00

(52) U.S. Cl. 165/41

(57) ABSTRACT

An air permeable protective camouflage screen is mounted in front of the air-intake side of a vehicle heat exchanger. The screen includes substantially horizontal and vertical intersecting walls, forming a plurality of apertures. The screen has at least two zones with apertures of different shapes for controlling air flow through the screen into the heat exchanger. The zones are oriented to allow relatively more air to pass into the first section of the heat exchanger having higher temperatures than the second section. The screen may include flaps mounted to the horizontal walls by living hinges, the flaps being disposed in the apertures when in a neutral closed position, being pivotable to allow air flow through the screen. The screen is substantially opaque when the flaps are in the neutral closed position, further camouflaging the heat exchanger, and the screen is made of non-corrosive material such as an organic polymeric material.

### CROSS REFERENCE TO RELATED APPLICATION

This application claims the benefit of Provisional Application Ser. No. 60/716,185 filed Sep. 12, 2005.

### BACKGROUND OF THE INVENTION

1. Field of the Invention

The present invention relates to a protective screen for attaching to a vehicle cooling assembly.

2. Description of the Prior Art

Screens used in conjunction with vehicle front end heat exchangers are known in the prior art. Examples of such assemblies are disclosed in U.S. Pat. No. 6,810,950 B1 to Manze III, U.S. Pat. No. 6,155,335 to Acre et al., U.S. Pat. No. 5,718,283 to Naty, U.S. Pat. No. 5,899,287 to Kadlubski, and U.S. Pat. No. 4,236,592 to Ziegler.

The Manze '950 patent Application discloses a tilting frame for mounting on a radiator to accommodate filtering material.

The Naty '283 patent discloses a detachable air filter with attachment elements for fastening the filter to the heat exchanger, the screen being a curtain of woven glass fiber coated with PVC.

The Kadlubski '287 patent discloses a protective cover including a tool storage area placed over a radiator for use when the radiator is serviced.

The Ziegler '592 patent discloses a protective structure for vehicles mounted on the front of the vehicle grill including a curtain alternated for cold weather operation and warm weather operation, as well as an air deflector mounted on the leading edge of the vehicle.

Although there are numerous protective screen assemblies, there remains an opportunity for an easily manufactured assembly that protects the heat exchanger from debris while controlling air flow and enhancing the appearance of the front end of the vehicle.

### SUMMARY OF THE INVENTION AND ADVANTAGES

The subject invention provides a vehicle cooling assembly, and includes a heat exchanger with an air-intake side and an air-outlet side opposite the air-intake side, and an air permeable protective screen in spaced relationship with the air-intake side of the heat exchanger, the screen comprising a matrix of intersecting walls defining a plurality of apertures. The screen includes a first zone with the plurality of apertures that have a first shape for controlling air flow through the first zone and a second zone with a plurality of apertures that have a second shape different from the first shape for restricting air flow through the second zone as compared to the air flow through the first zone.

Although vehicle cooling assembly screens have been employed extensively to protect heat exchangers from debris, the present invention controls the amount of air flow into sections of the heat exchanger, while at the same time, camouflaging the heat exchanger from view, and providing a customizable appearance.

### BRIEF DESCRIPTION OF DRAWINGS

Other advantages of the present invention will be readily appreciated, as the same becomes better understood by reference to the following detailed description when considered in connection with the accompanying drawings wherein:

FIG. 1 is a perspective view of a vehicle cooling assembly showing a heat exchanger;

FIG. 2 is a front view of a heat exchanger illustrating generally sections with different temperatures;

FIG. 3 is a front view of the heat exchanger with the screen illustrating three zones;

FIG. 3A is close-up front view of an alternative shape;

FIG. 3B is a close-up front view of an alternative shape;

FIG. 3B is a close-up front view of an alternative shape;

FIG. 4 is a perspective front view of a zone in the screen including flaps; and

FIG. 5 is a cross-sectional side view of a flap showing the neutral closed position and the open position in relation to the heat exchanger.

### DETAILED DESCRIPTION OF THE INVENTION

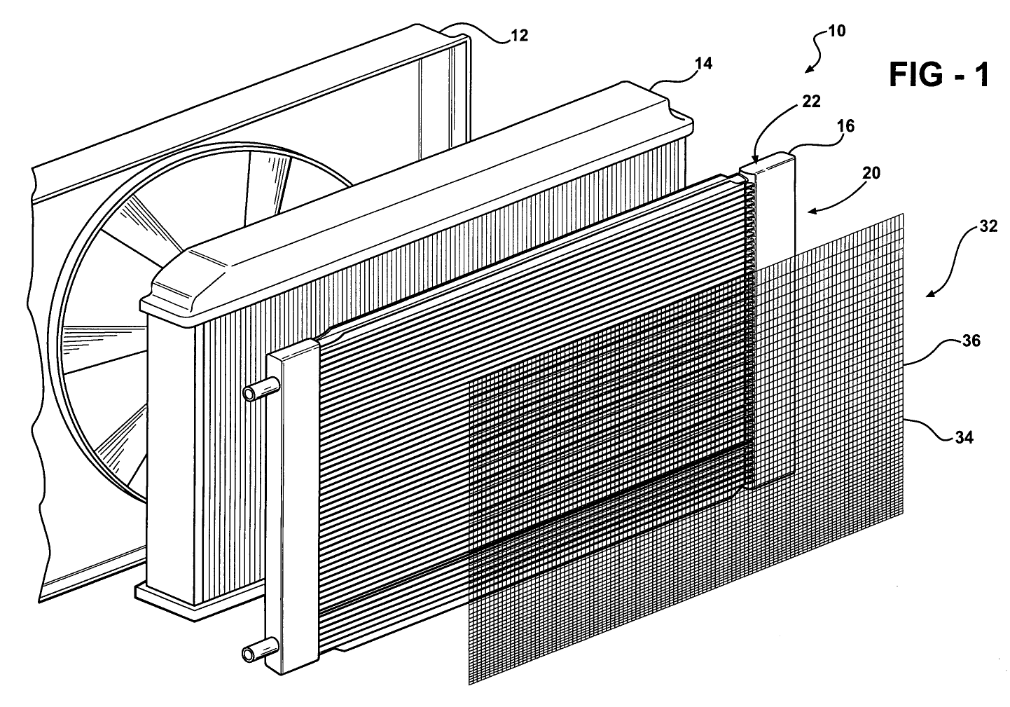

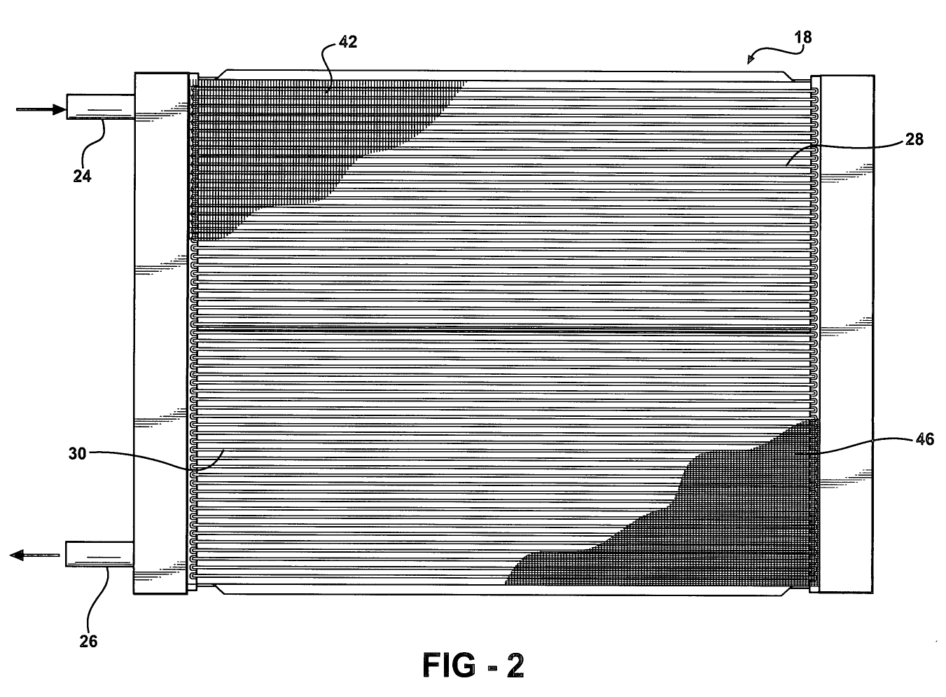

Referring to the Figures, wherein like numerals indicate corresponding parts throughout the several views, a vehicle cooling assembly 10 is generally shown at FIG. 1 and includes a fan 12 component and heat exchanging components such as a radiator 14 and condenser 16. The vehicle cooling assembly 10 includes a heat exchanger 18 having an air-intake side 20 and an air-outlet side 22 opposite the air-intake side 20. Referring to FIG. 2, the heat exchanger 18 includes an inlet 24 for receiving a refrigerant into the heat exchanger 18, and an outlet 26 for exiting the refrigerant from the heat exchanger 18. The temperature of the refrigerant at the inlet 24 is greater than the temperature of the refrigerant at the outlet 26, after the refrigerant has circulated through the heat exchanger 18, thus the temperature of a first section 28 of the heat exchanger 18 being associated with the inlet 24, is greater than the temperature of a second section 30 of the heat exchanger 18, being associated with the outlet 26. It can be readily appreciated that heat exchangers 18 do not necessarily have sections 28, 30 specifically defined by temperature but that temperature varies gradually within the heat exchanger 18. Similarly, there are many configurations for heat exchangers 18, including different inlet 24 and outlet 26 locations, and different refrigerant circulation paths, which result in a different temperature profiles between heat exchangers 18.

Referring to FIGS. 1-4, an air permeable protective screen 32 is in spaced relationship with the air-intake side 20 of the heat exchanger 18 with the screen 32 comprising a matrix of intersecting walls 34 defining a plurality of apertures 36. The walls 34 include substantially vertical walls 38 and substantially horizontal walls 40 that intersect at approximately ninety degree angles. Each aperture 36 generally has a top and bottom formed by the horizontal walls 40, and two sides 20, 22, formed by the vertical walls 38.

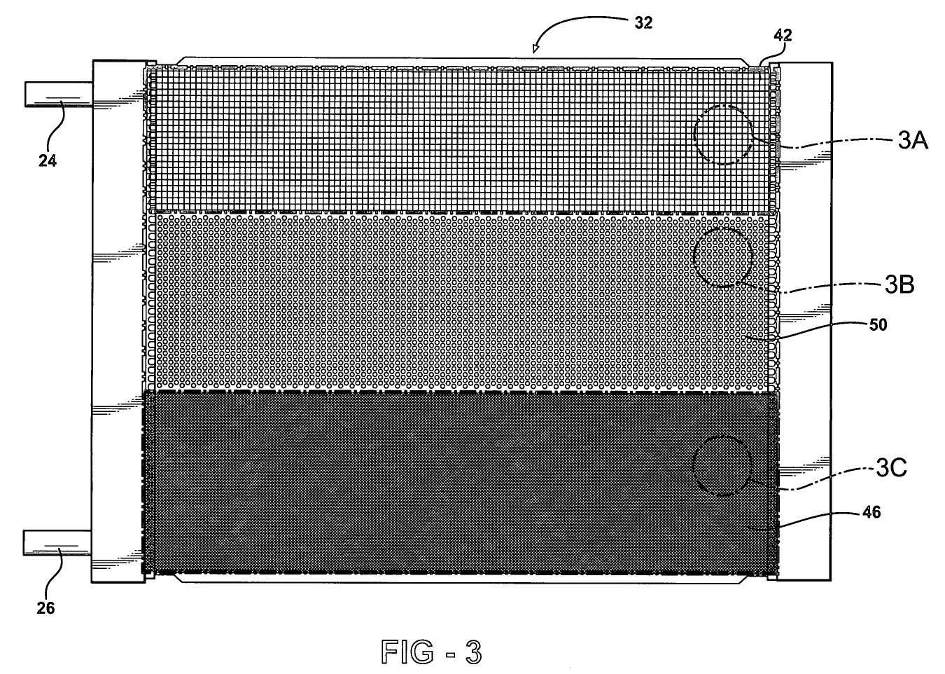

The screen 32 includes a first zone 42 with the plurality of apertures 36 having a first shape 44 and a second zone 46 with the plurality of apertures 36 having a second shape 48 different from the first shape 44. The first shape 44 and second shape 48 are closed. The first shape 44 defines a first closed area, and the second shape 48 defines a second closed area smaller than the first closed area. As a result, air flow through the second zone 46 is restricted as compared to the air flow through the first zone 42. Referring to FIG. 3, the screen 32 may include a third zone 50 with the plurality of apertures 36 having a third shape 52 different from the first shape 44 and the second shape 48, where the third shape 52 is closed defining a third closed area different from the first closed area and second closed area. The zones 42, 46, 50 are shown as generally rectangular from left to right, extending across the width of the screen 32, and are generally uniformly divided. Alternatively, the screen 32 may include zones 42, 46, 50 oriented differently from those illustrated, for instance, being generally vertical, having different proportions relative to one another, or being shapes other than rectangular, including but not limited to circles and triangles. In addition, the screen 32 may include additional zones with apertures of different shapes depending upon the amount of air flow desired through the screen 32. It can be readily appreciated that zones 42, 46, 50 can benefit from having apertures 36 which are graduated, for example as illustrated in FIG. 1, apertures 36 at the top of the zone have a greater area than those at the bottom of the zone. It can also be appreciated that though the shapes 44, 48, 52 are generally illustrated as rectangles, the apertures 36 may be in a range of shapes, as illustrated in FIGS. 3A-3C, including ellipses to polygons, and shapes 44, 48, 52 can vary between zones 42, 46, 50.

Referring to FIG. 2, the first zone 42 of the screen 32 is substantially disposed across the first section 28 of the heat exchanger 18 and the second zone 46 of the screen 32 is substantially disposed across the second section 30 of the heat exchanger 18. This allows for relatively greater air flow through the screen 32 to the first section 28 of the heat exchanger 18 of the heat exchanger 18 that has a relatively higher temperature than the second section 30 the heat exchanger 18. It can be readily appreciated that because there are a variety of configurations of heat exchangers 18, the composition of the zones 42, 46, 50 of the screen 32 can easily be modified to accommodate the air flow requirements of a variety of heat exchangers 18.

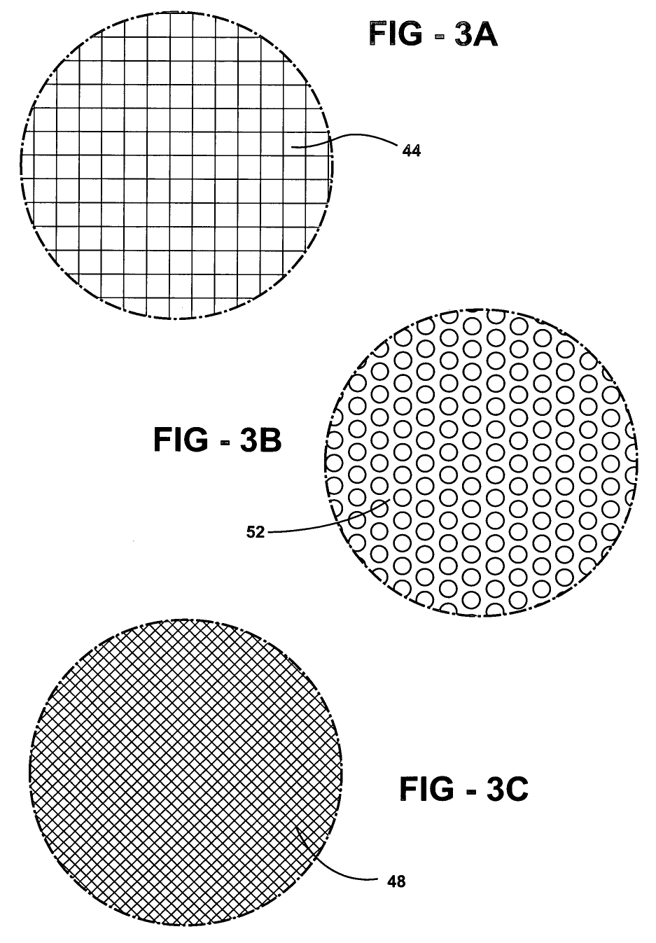

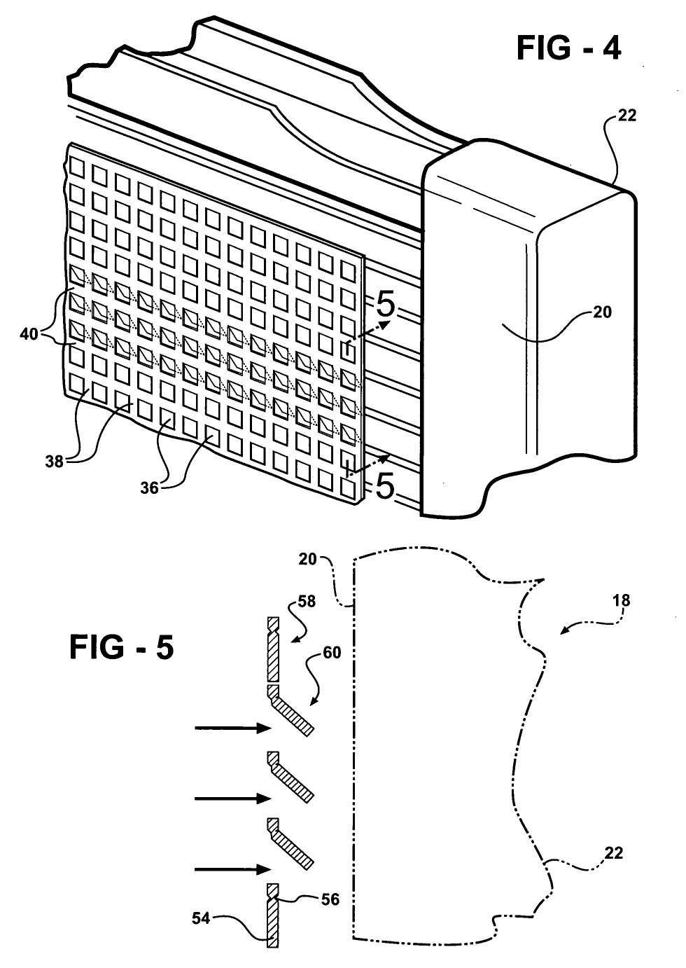

Referring to FIGS. 4-5, a plurality of flaps 54 may be mounted to the screen 32. The flaps 54 extend from the horizontal walls 40 that form the top of the apertures 36 and are mounted to the screen 32 by a living hinge 56. The living hinge 56 can consist of notches at the intersection of the flaps 54 and the horizontal walls 40, however can be manufactured in a variety of ways. The flaps 54 and living hinges 56 are made of material rigid enough to cause them to be biased toward a neutral closed position 58 while being flexible enough to be moved to an open position 60 extending outwardly from the screen 32 toward the air-intake side 20 of the heat exchanger 18 by air flowing through the screen 32. As can be appreciated by anyone skilled in the art, the result is that the pivotable flaps 54 allow air to flow through the screen 32, such as when the vehicle is moving, while making the screen 32 substantially opaque when the flaps 54 are in the neutral closed position 58, such as when the vehicle is stationary.

The screen 32 and flaps 54 comprise corrosion resistant material, for instance, an organic polymeric material such as polypropylene. The material can include at least one colored pigment, allowing the screen 32 or the screen 32 combined with flaps 54, to further camouflage the heat exchanger 18 and to have a customizable appearance visible from the front of the vehicle. For example, a uniform appearance would be created by the use of one color, such as black, while more than one colored pigment could be used to create an image, such as a logo.

Obviously, many modifications and variations of the present invention are possible in light of the above teachings without departing from the essential scope thereof. Therefore, it is intended that the invention not be limited to the particular embodiment disclosed, but that the invention will include all embodiments falling within the scope of the appended claims. The reference numerals are merely for convenience and are not to be read in any way as limiting.

What is claimed is:

1. A vehicle cooling assembly comprising;
a heat exchanger having an air-intake side and an air-outlet side opposite said air-intake side,
an air permeable protective screen in spaced relationship with said air-intake side of said heat exchanger with said screen comprising a matrix of intersecting walls defining a plurality of apertures, and
characterized by said screen including a first zone with said plurality of apertures in said first zone having a first shape for controlling air flow through said first zone and a second zone with said plurality of apertures in said second zone having a second shape different from said first shape for restricting air flow through said second zone as compared to the air flow through said first zone.

2. An assembly as set forth in claim 1 wherein said first shape is closed defining a first closed area.

3. An assembly as set forth in claim 2 wherein said second shape is closed defining a second closed area smaller than said first closed area.

4. An assembly as set forth in claim 3 including a third zone with said plurality of apertures in said third zone having a third shape different from said first shape and said second shape.

5. An assembly as set forth in claim 4 wherein said third shape is closed defining a third closed area different from said first closed area and second closed area.

6. An assembly as set forth in claim 1 including a plurality of flaps mounted to said screen and moveable between a neutral closed position disposed within said plurality of apertures and an open position extending outwardly from said screen.

7. An assembly as set forth in claim 6 including a living hinge disposed between each of said flaps and said screen.

8. An assembly as set forth in claim 7 wherein said flap is biased toward said neutral closed position.

9. An assembly as set forth in claim 8 wherein said flaps open toward said air-intake side of said heat exchanger when in said open position.

10. An assembly as set forth in claim 1 wherein said screen comprises corrosion resistant material.

11. An assembly as set forth in claim 10 wherein said corrosion resistant material is an organic polymeric material.

12. An assembly as set forth in claim 6 wherein said screen and said flaps comprise corrosion resistant material.

13. An assembly as set forth in claim 12 wherein said corrosion resistant material is an organic polymeric material.

14. An assembly as set forth in claim 6 wherein said walls include substantially vertical walls and substantially horizontal walls.

15. An assembly as set forth in claim 14 wherein said flaps extend from said horizontal walls.

16. An assembly as set forth in claim 1 wherein said heat exchanger includes a first section having an inlet and a second section having an outlet with a temperature at the first section being greater than a temperature at said second section.

17. An assembly as set forth in claim 16 wherein said first zone of said screen is substantially disposed across said first section of said heat exchanger and said second zone of said screen is substantially disposed across said second section of said heat exchanger.

18. A vehicle cooling assembly comprising;
a heat exchanger having an air-intake side and an air-outlet side opposite said air-intake side,
an air permeable protective screen in spaced relationship with said air-intake side of said heat exchanger with said screen comprising a matrix of intersecting substantially vertical walls and substantially horizontal walls defining a plurality of apertures, and
characterized by said screen including a plurality of flaps mounted to said horizontal walls and pivotable between a neutral closed position disposed within said plurality of apertures and an open position extending outwardly from said screen toward said air-intake side of said heat exchanger wherein said screen is substantially opaque when said flaps are in said neutral closed position.
